(19) United States
(12) Patent Application Publication
(10) Pub. No.: US 2025/0105560 A1
(43) Pub. Date: Mar. 27, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Daisuke SAITO, Mie (JP)

(21) Appl. No.: 18/729,886

(22) PCT Filed: Dec. 21, 2022
(86) PCT No.: PCT/JP2022/047070

§ 371 Date: Jul. 17, 2024

(30) Foreign Application Priority Data
Jan. 27, 2022 (JP) 2022-010629

(51) Int. Cl. H01R 13/641

(52) U.S. Cl. CPC H01R 13/641

(57) ABSTRACT

A connector includes a housing, an accommodating member and a detecting member. The accommodating member includes a stopper portion. The detecting member includes an arm portion. The detecting member is restricted from moving forward while being arranged at a standby position by a tip part of the arm portion butting against the stopper portion from behind. The tip part of the arm portion is pushed by the housing to move in a releasing direction, whereby the detecting member is allowed to move from the standby position to the detection position, in the process of properly fitting the housing into the accommodating member. The detecting member further includes a pressing portion. The detecting member is so arranged that the tip part of the arm portion is inclined in a direction opposite to the releasing direction when the pressing portion is pressed with the detecting member arranged at the standby position.

### TECHNICAL FIELD

The present disclosure relates to a connector.

### BACKGROUND

Conventionally, a connector provided with a detecting member is known. The connector of this type can detect that a housing has been properly connected to a mating housing if the detecting member reaches a detection position from a standby position. For example, in Patent Document 1, a CPA device (detecting member) is locked at a temporary locking position (standby position) and a movement to a complete locking position (detection position) is restricted in a state where the connector housing is not properly connected to the mating housing. The CPA device is released from a locked state at the temporary locking position and enabled to move to the complete locking position if the connector housing is properly connected to the mating housing. Therefore, this connector can detect that the connector housing has been properly connected to the mating housing if the CPA device reaches the complete locking position.

In the connector of this type, the locked state at the standby position may be unintentionally released due to the rattling of the detecting member. Accordingly, a connector of Patent Document 1 has the following configuration. That is, the CPA device is provided with an arm portion for coming into contact with a lock portion of the connector housing at the temporary locking position. The connector housing is provided with a guide groove for guiding the CPA device from the temporary locking position to the complete locking position. The CPA device is provided with a convex plate portion to be engaged with the guide groove. The convex plate portion is formed with a backlash preventing projection for inclining the CPA device in a direction to increase a locking margin of an engaging protrusion with the lock portion at the temporary locking position. According to this configuration, by preventing the rattling of the CPA device by the backlash preventing protrusion, the locking margin of the engaging protrusion with the lock portion is increased, wherefore unintentional release of the locked state at the temporary locking position is less likely to occur.

### PRIOR ART DOCUMENT

### Patent Document

Patent Document 1: JP 2021-068497 A

### SUMMARY OF THE INVENTION

### Problems to be Solved

However, in the connector of Patent Document 1, a friction force generated when the CPA device is pushed in increases by preventing ratting by the backlash preventing protrusion. Thus, a force for pushing in the CPA device tends to increase.

Accordingly, the present disclosure aims to provide a technique capable of making unintentional release of a locked state at a temporary locking position less likely to occur even without preventing rattling.

### Means to Solve the Problem

The present disclosure is directed to a connector with a housing, an accommodating member, the housing being fit into the accommodating member from behind, and a detecting member to be mounted into the accommodating member movably between a standby position and a detection position forward of the standby position, the accommodating member including a stopper portion, the detecting member including an arm portion cantilevered forward, the detecting member being restricted from moving forward while being arranged at the standby position by a tip part of the arm portion butting against the stopper portion from behind, the tip part of the arm portion being pushed by the housing to move in a releasing direction, whereby the detecting member is allowed to move from the standby position to the detection position, in the process of properly fitting the housing into the accommodating member, the detecting member further including a pressing portion, and the detecting member being so arranged that the tip part of the arm portion is inclined in a direction opposite to the releasing direction when the pressing portion is pressed with the detecting member arranged at the standby position.

### Effect of the Invention

According to the present disclosure, it is possible to make unintentional release of a locked state at a temporary locking position less likely to occur even without preventing rattling.

### BRIEF DESCRIPTION OF THE DRAWINGS

FIG. 1 is a perspective view of a connector coupling structure in which a connector of one embodiment is coupled to a mating connector.

FIG. 2 is a side view in section of the connector coupling structure.

FIG. 3 is a perspective view of the connector.

FIG. 4 is a perspective view of a detecting member when viewed from above.

FIG. 5 is a perspective view of the detecting member when viewed from below.

FIG. 6 is a side view in section showing a state where the detecting member is arranged at a standby position.

FIG. 7 is a side view in section cut by a plane passing through a guide portion and guide projections in the same state as that shown in FIG. 6.

FIG. 8 is a side view in section showing a state where a locked state of the detecting member at the standby position is released.

FIG. 9 is a side view in section showing an intermediate state during a movement of the detecting member from the standby position to a detection position.

FIG. 10 is a side view in section cut by the plane passing through the guide portion and the guide projections in the same state as that shown in FIG. 9.

FIG. 11 is a side view in section showing a state where the detecting member is arranged at the detection position.

FIG. 12 is a side view in section cut by the plane passing through the guide portion and the guide projections in the same state as that shown in FIG. 11.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing, an accommodating member, the housing being fit into the accommodating member from behind, and a detecting member to be mounted into the accommodating member movably between a standby position and a detection position forward of the standby position, the accommodating member including a stopper portion, the detecting member including an arm portion cantilevered forward, the detecting member being restricted from moving forward while being arranged at the standby position by a tip part of the arm portion butting against the stopper portion from behind, the tip part of the arm portion being pushed by the housing to move in a releasing direction, whereby the detecting member is allowed to move from the standby position to the detection position, in the process of properly fitting the housing into the accommodating member, the detecting member further including a pressing portion, and the detecting member being so arranged that the tip part of the arm portion is inclined in a direction opposite to the releasing direction when the pressing portion is pressed with the detecting member arranged at the standby position.

According to this configuration, since the tip part of the arm portion is inclined in the direction opposite to the releasing direction when the pressing portion of the detecting member is pressed, a locked state of the arm portion and the stopper portion is less likely to be released. Moreover, the rattling of the detecting member needs not be prevented. Therefore, according to this configuration, unintentional release of the locked state at the standby position can be made less likely to occur even without preventing rattling.

(2) Preferably, the pressing portion has a pressing surface, and the pressing surface is so inclined that an end part on the releasing direction side is inclined in a connection direction of the housing with the detecting member arranged at the standby position.

According to this configuration, the entire detecting member is easily displaced such that a tip side is inclined in the direction opposite to the releasing direction when the pressing surface is pressed with the detecting member arranged at the standby position, with the result that the tip part of the arm portion is easily inclined in the direction opposite to the releasing direction. Therefore, according to this configuration, the locked state of the arm portion and the stopper portion is less likely to be released and unintentional release of the locked state at the standby position can be made less likely to occur.

(3) Preferably, a center of the pressing surface is arranged more on the releasing direction side than a virtual line parallel to the connection direction of the housing and passing through a support point where the detecting member is supported in the accommodating member.

According to this configuration, a force applied to the releasing direction side when the pressing surface is pressed tends to increase. If a force is applied to the releasing direction side of the pressing surface, a moment is generated about the support point, wherefore the tip part of the arm portion is inclined in the direction opposite to the releasing direction. Thus, according to this configuration, the locked state of the arm portion and the stopper portion is less likely to be released and unintentional release of the locked state at the standby position can be made less likely to occur.

(4) Preferably, the accommodating member includes a guide portion for guiding the detecting member from the standby position to the detection position, and the guide portion guides the detecting member such that an angle of inclination of the pressing surface to a plane orthogonal to the connection direction of the housing is smaller when the detecting member is arranged at the detection position than when the detecting member is arranged at the standby position.

According to this configuration, an increase in the deformation amount of the arm portion can be suppressed as the detecting member moves from the standby position to the detection position.

(5) Preferably, the arm portion has a tip surface to be butted against the stopper portion from behind, and the tip surface is so inclined that an end part on the releasing direction side is inclined in a direction opposite to the connection direction of the housing with the detecting member arranged at the standby position.

According to this configuration, even if the pressing portion is pressed and the tip surface butts against the stopper portion with the detecting member arranged at the standby position, the tip surface hardly moves in the releasing direction, wherefore the tip surface hardly rides on the releasing direction side of the stopper portion.

(6) Preferably, the detecting member includes a retaining portion, the retaining portion is arranged at a position allowing the housing to be fit into the accommodating member with the detecting member arranged at the standby position, and the retaining portion is arranged at a position preventing the housing from coming out rearward with the detecting member arranged at the detection position.

According to this configuration, the housing can be prevented from coming out rearward by the retaining portion after the housing is fit into the accommodating member.

(7) Preferably, the retaining portion constitutes a part of the pressing portion.

According to this configuration, the retaining portion can also function as a part of the pressing portion.

### Details of Embodiment of Present Disclosure

### Embodiment

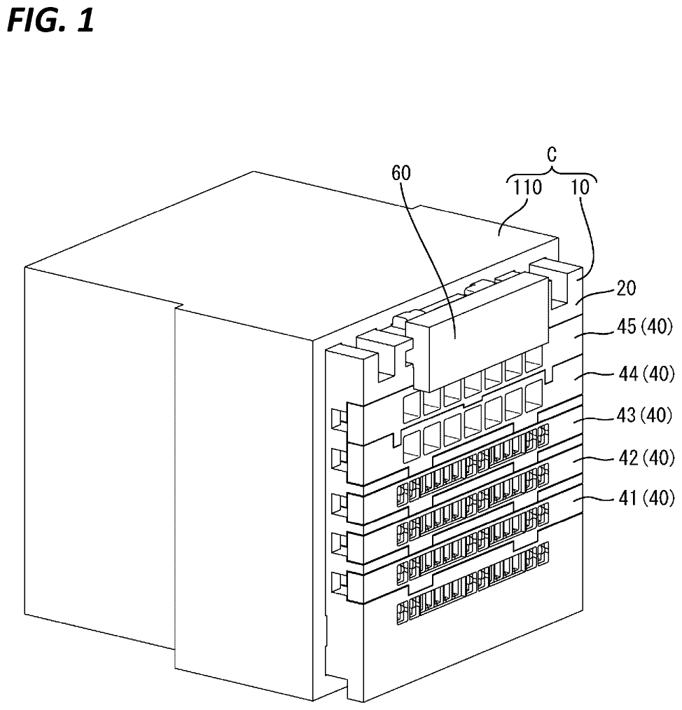

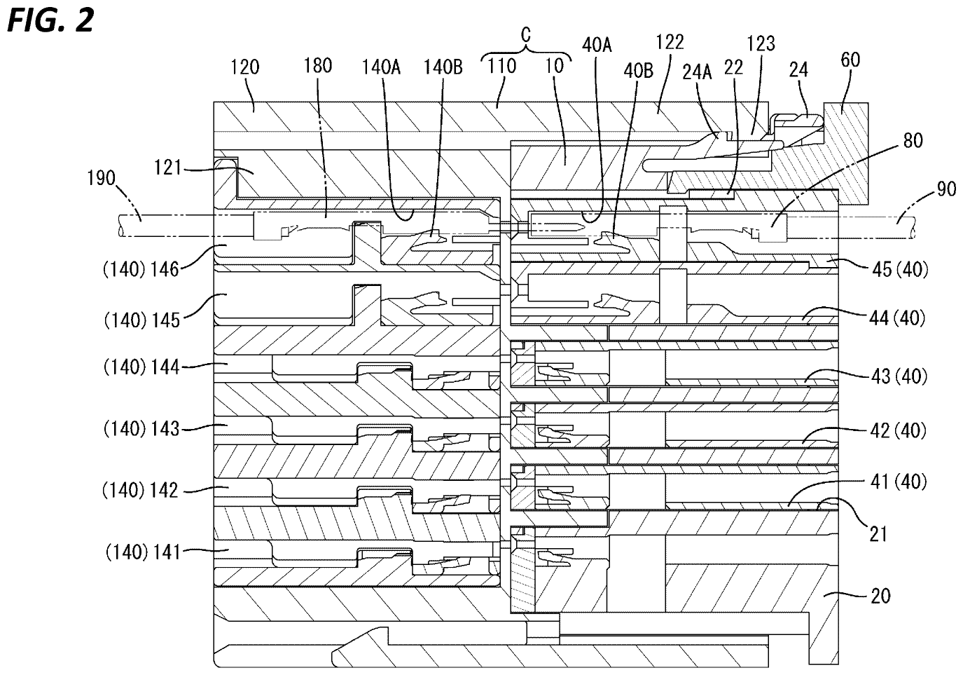

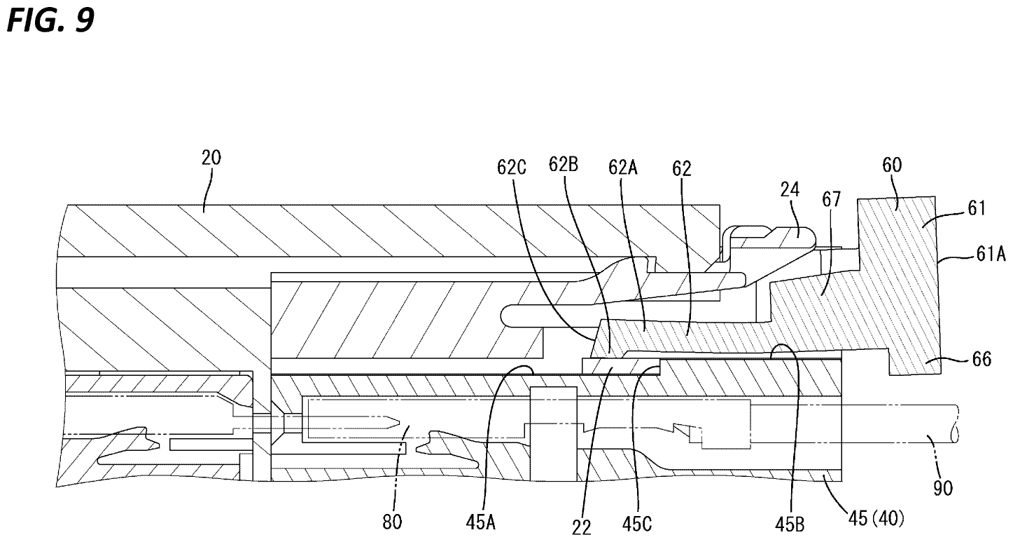

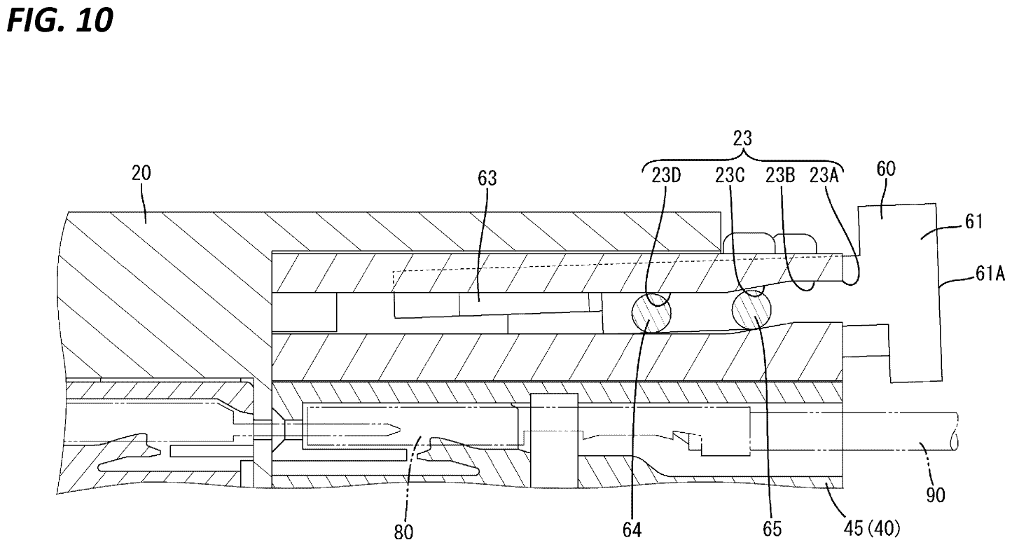

One embodiment is described with reference to FIGS. 1 to 12. FIGS. 1 and 2 show a connector coupling structure C in which a connector 10 of this embodiment is coupled to a mating connector 110. Note that, in this embodiment, a connection direction is defined as a forward direction and a separation direction is defined as a rearward direction for each of the connector 10 and the mating connector 110 concerning a front-rear direction. Upper and lower sides shown in FIGS. 1 to 12 are directly defined as upper and lower sides concerning a vertical direction. A direction orthogonal to the planes of FIGS. 2 and 6 to 12 (direction orthogonal to the front-rear direction and vertical direction) is defined as a width direction. Note that an upward direction corresponds to an example of a “releasing direction”.

### <Configuration of Connector>

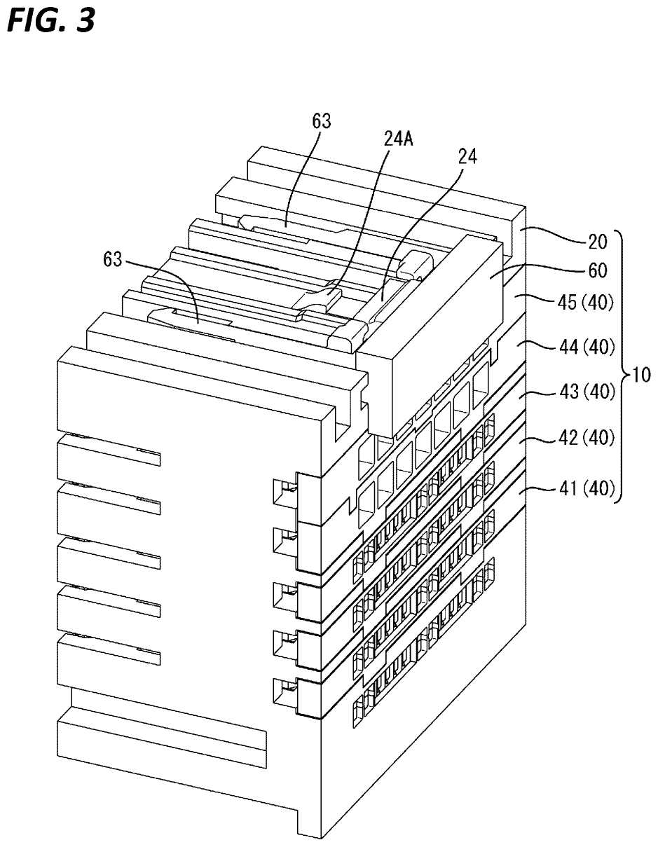

As shown in FIGS. 2 and 3, the connector 10 is provided with a holder 20, sub-housings 40, a detecting member 60 and terminal fittings 80. The holder 20 corresponds to an example of an “accommodating member”. The sub-housings 40 are fit into the holder 20 from behind. The sub-housing 40 (more specifically, the sub-housing 45 arranged in the uppermost stage, out of the plurality of sub-housings 40) corresponds to an example of a “housing”. The detecting member 60 is arranged movably between a standby position and a detection position forward of the standby position with respect to the holder 20. The detecting member 60 is locked to the holder 20 from front when reaching the standby position, and restricted from moving from the standby position to the detection position. The detecting member 60 is released from a locked state with the holder 20 and allowed to move to the detection position by being pressed by the sub-housing 40 (more specifically, the sub-housing 45) in the process of properly fitting the sub-housings 40 into the holder 20. Therefore, the connector 10 can detect that the sub-housings 40 (more specifically, the sub-housing 45) have been properly fit if the detecting member 60 reaches the detection position.

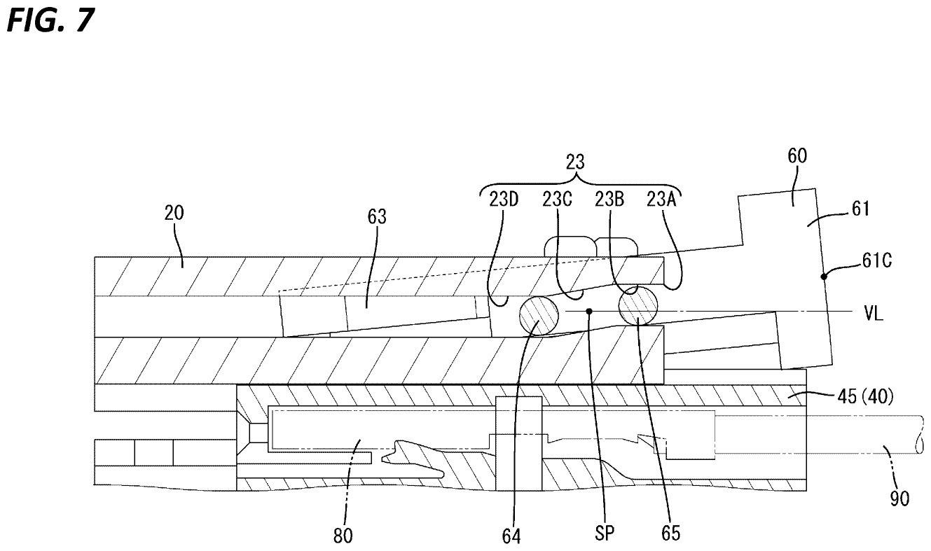

The holder 20 has an insulating property. The holder 20 is made of synthetic resin. As shown in FIGS. 2 and 7, the holder 20 includes an accommodating portion 21, a stopper portion 22, a guide portion 23 and a lock arm 24.

The accommodating portion 21 is open in the rear surface of the holder 20. The sub-housings 21 are fit into the accommodating portion 21 from behind.

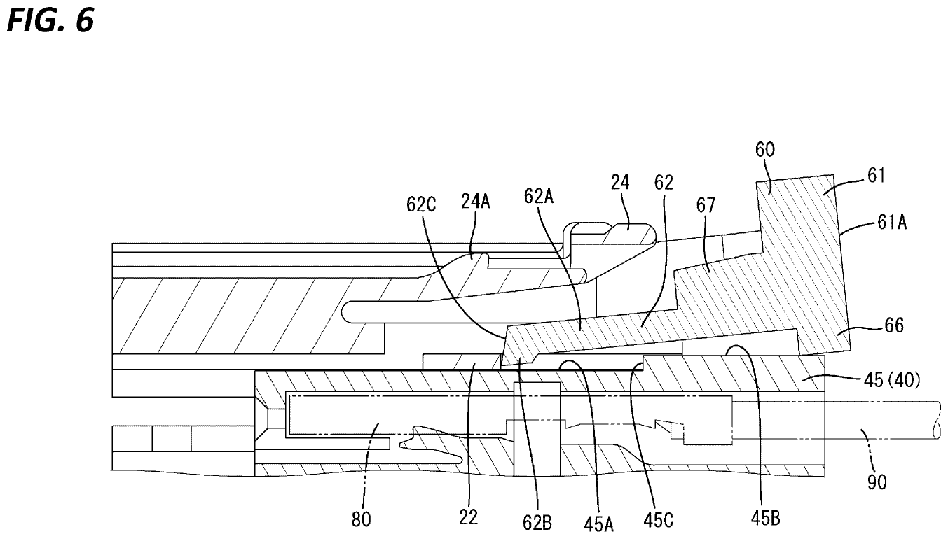

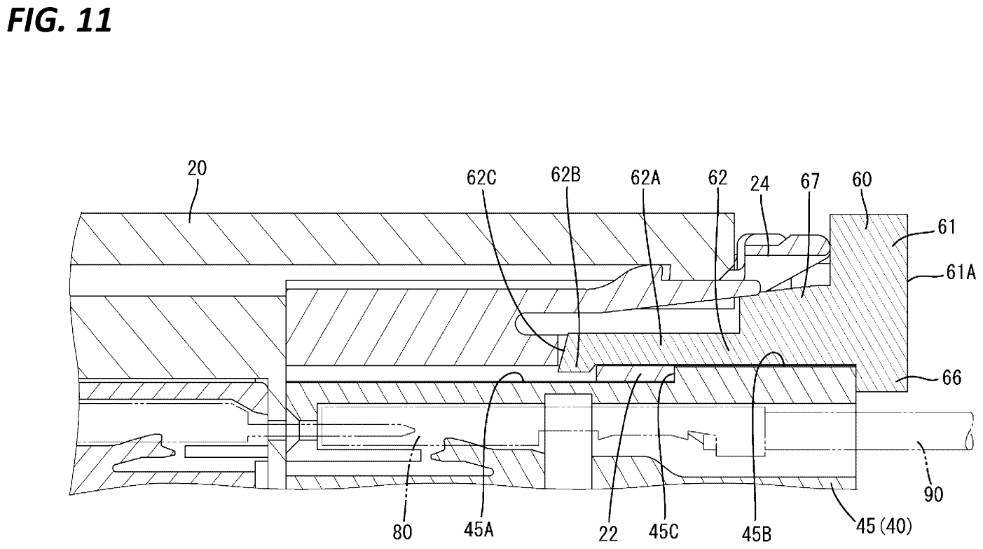

As shown in FIGS. 6 and 11, the stopper portion 22 locks the detecting member 60 arranged at the standby position from front and locks the detecting member 60 arranged at the detection position from behind. The stopper portion 22 is formed to extend in the width direction and has a rectangular shape long in the front-rear direction in a side cross-sectional view. The upper and lower surfaces of the stopper portion 22 are flat surfaces along the front-rear direction and width direction. The front and rear surfaces of the stopper portion 22 are flat surfaces along the vertical direction and width direction. The stopper portion 22 constitutes a part of the upper inner wall of the accommodating portion 21. The sub-housing 40 (more specifically, the sub-housing 45) is fit into the accommodating portion 21 along the lower surface of the stopper portion 22. That is, with the sub-housing 40 (more specifically, the sub-housing 45) properly fit in the accommodating portion 21, the lower surface of the stopper portion 22 is arranged adjacent to or facing the upper surface of the sub-housing 40 (more specifically, the sub-housing 45).

The guide portion 23 guides the detecting member 60 arranged at an initial position of the guide portion 23 to the standby position and guides the detecting member 60 from the standby position to the detection position. As shown in FIGS. 7, 10 and 12, the guide portion 23 is configured as a guide groove. The guide portion 23 includes an entrance 23A, a first guide portion 23B, a second guide portion 23C and a third guide portion 23D. The entrance 23A is open in the rear surface of the holder 20. The first guide portion 23B linearly extends forward from the entrance 23A. The second guide portion 23C is inclined downward toward the front from the front end of the first guide portion 23B. The third guide portion 23D linearly extends forward from the front end of the second guide portion 23C. The third guide portion 23D is arranged below the first guide portion 23B.

As shown in FIG. 11, the lock arm 24 is cantilevered rearward from a deflection fulcrum provided at a position forward of the stopper portion 22 and an extending end side is deflectable and deformable in the vertical direction. The lock arm 24 is arranged at a position above the stopper portion 22. The lock arm 24 includes an outer locking portion 24A provided on an upper surface. The outer locking portion 24A is locked to the mating connector 110.

The sub-housing 40 has an insulating property. The sub-housing 40 is made of synthetic resin. As shown in FIG. 2, the sub-housing 40 includes cavities 40A and locking lances 40B. The cavity 40A is open in the rear surface of the sub-housing 40. The terminal fitting 80 is inserted into the cavity 40A from behind. The locking lance 40B projects into the cavity 40A. The locking lance 40B prevents the terminal fitting 80 arranged in the cavity 40A from coming out rearward.

A plurality of (five in this embodiment) sub-housings 40 are provided. The five sub-housings 40 are also referred to as the sub-housings 41, 42, 43, 44 and 45. The sub-housings 41 to 45 respectively have a flat shape long in the width direction and are successively arranged from below. Since a housing is composed of the plurality of sub-housings 41 to 45 in the connector 10 as just described, a fitting force can be reduced.

Although not shown, the sub-housing 42 to 45 is restricted from moving forward by interfering with the lower sub-housing 41 to 44 with the lower sub-housing 41 to 44 incompletely fit in the holder 20. Further, the sub-housing 41 to 44 is restricted from moving rearward by interfering with the upper sub-housing 42 to 45 with the upper sub-housing 42 to 45 completely fit in the holder 20. Thus, the sub-housings 41 to 45 are successively fit into the accommodating portion 21 from below. In this way, the lower sub-housing 41 to 44 is prevented from coming out rearward by the upper sub-housing 42 to 45. The sub-housing 45 arranged in the uppermost stage is prevented from coming out rearward by the detecting member 60.

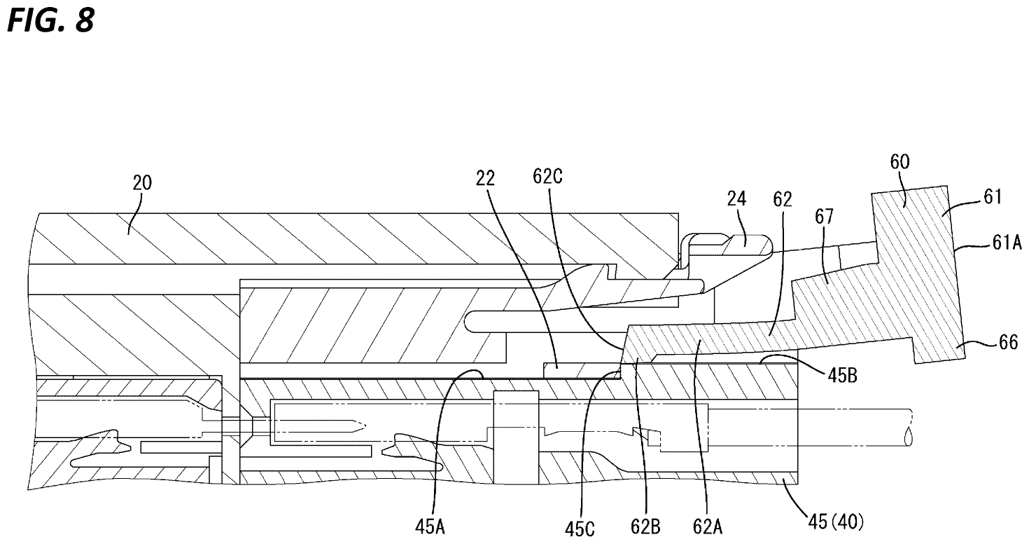

The sub-housing 45 arranged in the uppermost stage is fit into the accommodating portion 21 along the lower surface of the stopper portion 22. As shown in FIG. 6, the sub-housing 45 includes a first surface 45A, a second surface 45B and a releasing portion 45C. The first surface 45A is formed on the upper surface of the sub-housing 45 and arranged adjacent to or facing the lower surface of the stopper portion 22 with the detecting member 60 arranged at the detection position (see FIG. 11). The second surface 45B is formed on the upper surface of the sub-housing 45 at a position behind and above the first surface 45A. The releasing portion 45C is formed to protrude upward from a rear end part of the first surfaces 45A. The releasing portion 45C is configured as a step provided between the first and second surfaces 45A, 45B. The releasing portion 45C is a flat surface along the vertical direction and width direction. A height (vertical length from the first surface 45A) of the releasing portion 45C is equal to or larger than that of the stopper portion 22. The releasing portion 45C pushes and lifts the detecting member 60 arranged at the standby position upward in the process of fitting the sub-housing (more specifically, the sub-housing 45) into the holder 20 (see FIG. 8). In this way, a locked state of the stopper portion 22 and the detecting member 60 is released and the detecting member 60 is allowed to move to the detection position.

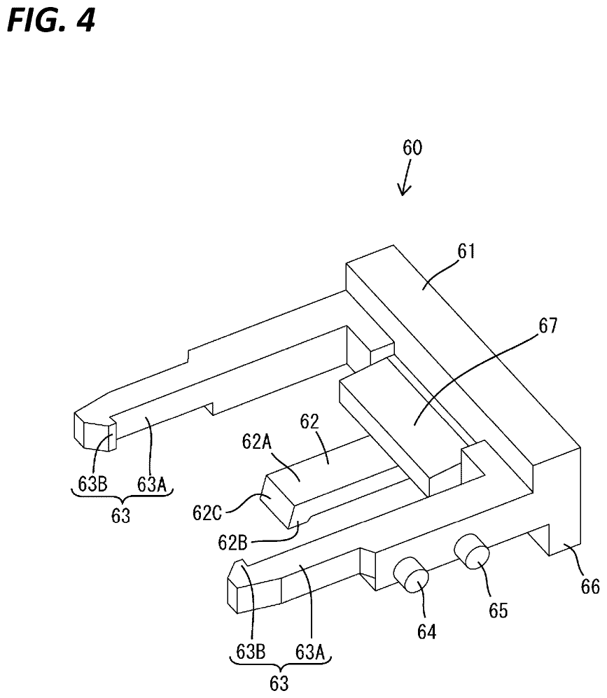

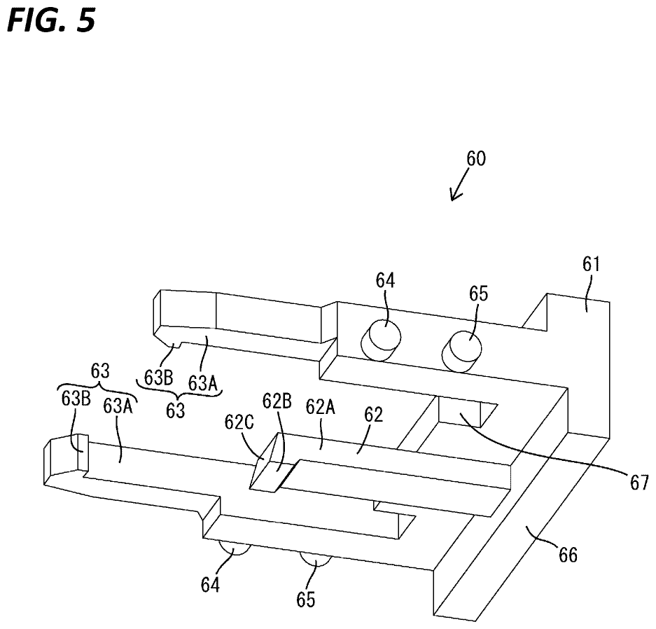

The detecting member 60 has an insulating property. The detecting member 60 is made of synthetic resin. As shown in FIGS. 4 and 5, the detecting member 60 includes a pressing portion 61, an arm portion 62, locking arms 63, guide projections 64, 65, a retaining portion 66 and a deflection restricting portion 67.

The pressing portion 61 is a part for pressing the detecting member 60 forward and provided in a rear end part of the detecting member 60. The pressing portion 61 is formed to be long in the width direction. The pressing portion 61 has a pressing surface 61A on a rear surface. The pressing surface 61A is a flat surface. The pressing surface 61A has a rectangular shape long in the width direction.

The arm portion 62 is cantilevered forward from a widthwise central part of the pressing portion 61 and a tip side thereof is deflectable and deformable in the vertical direction. A deflection direction of the arm portion 62 is a direction intersecting a moving direction of the detecting member 60 between the standby position and the detection position. The arm portion 62 includes an arm body 62A cantilevered forward from the pressing portion 61 and a locking portion 62B projecting downward from a tip part of the arm body 62A. The locking portion 62B of the arm portion 62 is locked to the holder 20. The arm portion 62 has a tip surface 62C. The tip surface 62C is a flat surface. The tip surface 62C butts against the stopper portion 22 from behind when the detecting member 60 reaches the standby position. In this way, a forward movement of the detecting member 60 is restricted.

The locking arms 63 are respectively cantilevered forward from both widthwise end parts of the pressing portion 61 and tip sides thereof are deflectable and deformable in the width direction. The locking arms 63 are paired in the width direction. The front ends of the locking arms 63 are arranged at positions forward of that of the arm portion 62. Each of the pair of locking arms 63 includes a locking arm body 63B cantilevered forward from the pressing portion 61 and a locking projection 63B projecting inward in the width direction from a tip part of the locking arm body 63A. The locking projections 63B of the locking arms 63 are locked to the holder 20 when the detecting member 60 is arranged at the standby position. In this way, a rearward movement of the detecting member 60 is restricted. That is, the detecting member 60 arranged at the standby position is restricted from moving in the front-rear direction by the arm portion 62 and the locking arms 63.

The guide projections 64, 65 project outward from the outer side surface of each of the pair of locking arms 63. The guide projections 64, 65 are arranged at an interval from each other in the front-rear direction. The guide projection 64, 65 has a cylindrical shape. An axial direction of the guide projection 64, 65 is along the width direction. The guide projection 64, 65 is fit into the groove-like guide portion 23 and guided along the guide portion 23. In this way, the detecting member 60 is guided from the initial position to the standby position and guided from the standby position to the detection position by the guide portion 23.

The retaining portion 66 is provided in the rear end part of the detecting member 60. The retaining portion 66 constitutes a part of the pressing portion 61. Thus, the pressing portion 61 is configured to be larger and easily pressable. The retaining portion 66 protrudes further downward than the lower end of the arm body 62A in the arm portion 62. The retaining portion 66 is arranged behind the sub-housing 40 (more specifically, the sub-housing 45) properly fit in the holder 20 and retains the sub-housing 40 (more specifically, the sub-housing 45) with the detecting member 60 arranged at the detection position (see FIG. 11).

The deflection restricting portion 67 is formed to project forward from the pressing portion 61 at a position above the arm portion 62. The front end of the deflection restricting portion 67 is arranged at a position rearward of the front end of the arm portion 62. The deflection restricting portion 67 has a rectangular shape long in the width direction in a plan view. The deflection restricting portion 67 is arranged at a position below the lock arm 24 and interferes with the lock arm 24 being deflected and deformed downward to restrict the deflection and deformation of the lock arm 24 with the detecting member 60 arranged at the detection position (see FIG. 11).

As shown in FIG. 2, the terminal fitting 80 is a female terminal fitting. The terminal fitting 80 is electrically conductive. The terminal fitting 80 is formed, such as by bending a metal plate. A wire 90 is electrically connected to a rear end side of the terminal fitting 80 by crimping or the like.

### <Configuration of Mating Connector>

As shown in FIG. 2, the mating connector 110 is provided with a mating holder 120, mating sub-housings 140 and mating terminal fittings 180.

The mating holder 120 is provided with a mating accommodating portion 121, a receptacle 122 and an inner locking portion 123. The mating accommodating portion 121 is open in the rear surface of the mating holder 120.

The receptacle 122 is in the form of a tube (more specifically, a rectangular tube) projecting rearward from an outer peripheral part of the mating accommodating portion 121. The connector 10 is fit into the receptacle 122.

The inner locking portion 123 is provided on an inner side of a projecting end part of the receptacle 122. The inner locking portion 123 is locked to the outer locking portion 24A of the lock arm 24 in the connector 10.

The mating sub-housing 140 has an insulating property. The mating sub-housing 140 is made of synthetic resin. The mating sub-housing 140 includes cavities 140A and locking lances 140B. The cavity 140A is open in the rear surface of the mating sub-housing 140. The terminal fitting 180 is inserted into the cavity 140A from behind. The locking lance 140B projects into the cavity 140A. The locking lance 140B prevents the terminal fitting 180 arranged in the cavity 140A from coming out rearward.

A plurality of (six in this embodiment) the mating sub-housings 140 are provided. Hereinafter, the six mating sub-housings 140 are also referred to as the mating sub-housings 141, 142, 143, 144, 145 and 146. The mating sub-housings 141 to 146 respectively have a flat shape long in the width direction and are successively arranged from below.

The mating terminal fitting 180 is a male terminal fitting. The mating terminal fitting 180 is electrically conductive. The mating terminal fitting 180 is formed, such as by bending a metal plate. A wire 190 is electrically connected to a rear end side of the terminal fitting 180 by crimping or the like.

### <Functions and Effects of Connector>

The connector 10 is assembled as follows. First, as shown in FIGS. 6 and 7, the detecting member 60 is arranged at the standby position with respect to the holder 20. Specifically, the guide projections 64, 65 of the detecting member 60 are respectively fit into the guide portion 23 through the entrance 23A of the holder 20 and move along the guide portion 23. The detecting member 60 is restricted from moving forward by the tip surface 62C of the arm portion 62 butting against the rear surface of the stopper portion 22. In this way, the detecting member 60 is arranged at the standby position.

Clearances are present between the guide projections 64, 65 and the guide portion 23. Thus, the detecting member 60 may rattle and the tip part of the arm portion 62 may be inclined upward and ride on the upper surface of the stopper portion 22. In this respect, with the detecting member 60 arranged at the standby position, the detecting member 60 is arranged in such an orientation that the tip part of the arm portion 62 is inclined downward when the pressing portion 61 is pressed. Specifically, the pressing surface 61A is so inclined that an upper end part is inclined in a connection direction (forward in this embodiment) of the sub-housing 40 with the detecting member 60 arranged at the standby position. According to this configuration, the tip part of the arm portion 62 is easily inclined downward and a locked state of the arm portion 62 and the stopper portion 22 is less likely to be released when the pressing surface 61A is pressed with the detecting member 60 arranged at the standby position.

Further, a center 61C of the pressing surface 61A is arranged above a virtual line VL parallel to the connection direction of the sub-housing 40 (front-rear direction in this embodiment) and passing through a support point SP where the detecting member 60 is supported in the holder 20. The support point SP is a midpoint between the guide projections 64 and 65. According to this configuration, a force applied to an upper end side of the pressing surface 61A when the pressing surface 61A is pressed tends to increase. If a force is applied to the upper end side of the pressing surface 61A, a moment is generated about the support point SP, whereby the tip part of the arm portion 62 is inclined downward. Thus, the locked state of the arm portion 62 and the stopper portion 22 is less likely to be released.

Further, the tip surface 62C of the arm portion 62 is so inclined that the upper end part is inclined rearward with the detecting member 60 arranged at the standby position. According to this configuration, even if the pressing portion 61 is pressed and the tip surface 62C butts against the stopper portion 22 with the detecting member 60 arranged at the standby position, the tip surface 62C hardly rides on the upper surface of the stopper portion 22 since the tip surface 62C hardly moves upward. That is, according to this configuration, the locked state of the arm portion 62 and the stopper portion 22 is less likely to be released.

After the detecting member 60 is arranged at the standby position, the sub-housing 45 in the uppermost stage is properly fit into the holder 20. In the process of properly fitting the sub-housing 45, the locked state of the detecting member 60 at the standby position is released. Specifically, the rear surface of the locking portion 62B of the arm portion 62 is so inclined that a lower end part is inclined forward with the detecting member 60 arranged at the standby position. In the process of properly fitting the sub-housing 45, the rear surface of the locking portion 62B is pressed by the releasing portion 45C of the sub-housing 45 and, as shown in FIG. 8, rides on the second surface 45B. In this way, the tip part of the arm portion 62 is arranged at a position above the stopper portion 22. That is, the locked state of the arm portion 62 and the stopper portion 22 is released and the detecting member 60 is allowed to move to the detection position.

If the detecting member 60 is pressed by the pressing surface 61A with the locked state at the standby position released, the detecting member 60 moves forward along the guide portion 23 and reaches the detection position as shown in FIGS. 8 to 11. The arm portion 62 of the detecting member 60 moves along the upper surface of the stopper portion 22 with the tip part deflected and deformed upward in the process of bringing the detecting member 60 to the detection position. If the locking portion 62B of the arm portion 62 reaches a position forward of the stopper portion 22, the locking portion 62B returns to an original shape due to a resilient force thereof and is locked to the stopper portion 22 from behind. In this way, the detecting member 60 is prevented from coming out rearward. Further, the retaining portion 66 of the detecting member 60 is arranged adjacent to or facing the rear surface of the sub-housing 40 (more specifically, the sub-housing 45). In this way, the retaining portion 66 prevents the sub-housing 45 from coming out rearward. Further, the deflection restricting portion 67 is arranged adjacent to or facing the lower surface of the lock arm 24 of the holder 20. In this way, the deflection restricting portion 67 restricts downward deflection and deformation of the lock arm 24. As a result, the lock arm 24 is suppressed from being disengaged against intention.

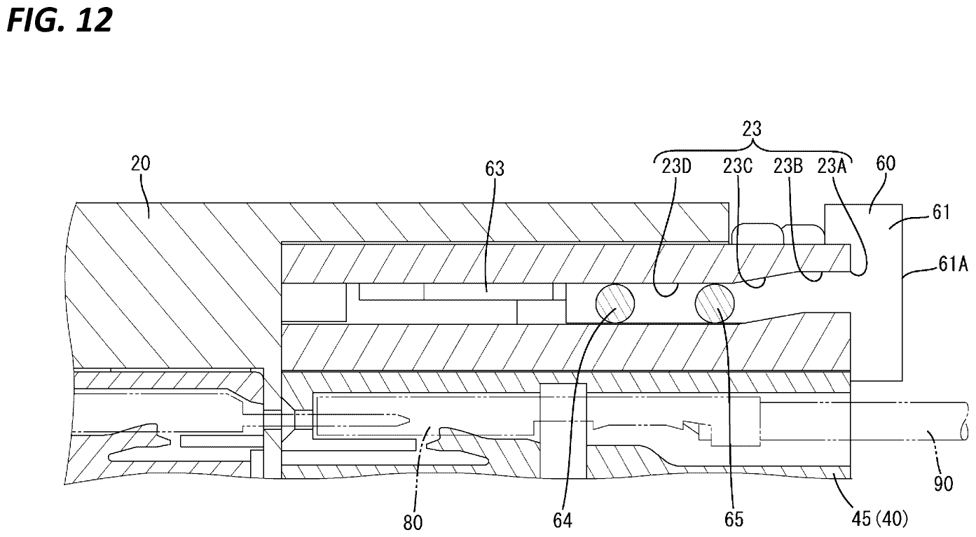

As shown in FIGS. 7, 10 and 12, the guide portion 23 guides the detecting member 60 such that an angle of inclination of the pressing surface 61A to a plane orthogonal to the connection direction of the sub-housing 40 is smaller when the detecting member 60 is arranged at the detection position than when the detecting member 60 is arranged at the standby position. Specifically, with the detecting member 60 arranged at the standby position, a center of the front guide projection 64 is in the third guide portion 23D and a center of the rear guide projection 65 is arranged in the second guide portion 23B as shown in FIG. 7. In contrast, with the detecting member 60 arranged at the detection position, the guide projections 64, 65 are both arranged in the third guide portion 23D as shown in FIG. 12. In this way, the angle of inclination of the pressing surface 61A to the plane orthogonal to the connection direction of the sub-housing 40 is smaller when the detecting member 60 is arranged at the detection position than when the detecting member 60 is arranged at the standby position. According to this configuration, as the detecting member 60 moves from the standby position toward the detection position, an increase in the deformation amount of the arm portion 62 can be suppressed.

### Other Embodiments of Present Disclosure

The present invention is not limited to the above described and illustrated embodiment, but is represented by claims. The present invention is intended to include all changes in the scope of claims and in the meaning and scope of equivalents and also include the following embodiments.

(1) Although the housing is the sub-housing and the accommodating member is the holder in the above embodiment, another configuration may be adopted. For example, the housing may be a first housing and the accommodating member may be a second housing to be connected to the first housing.

(2) Although the pressing portion has the pressing surface in the above embodiment, the pressing portion may not have the pressing surface. For example, the pressing portion may have a step shape.

(3) Although the tip surface of the arm portion is so inclined that the end part on the releasing direction side is inclined in a direction opposite to the connection direction of the housing with the detecting member arranged at the standby position in the above embodiment, another configuration may be adopted. For example, the tip surface of the arm portion may not be inclined or may be so inclined that the end part on the releasing direction side is inclined in the connection direction of the housing with the detecting member arranged at the standby position.

(4) Although the detecting member includes the retaining portion in the above embodiment, the detecting member may not include the retaining portion.

(5) Although the retaining portion constitutes a part of the pressing portion in the above embodiment, the pressing portion may not constitute a part of the pressing portion.

### LIST OF REFERENCE NUMERALS

10 . . . connector
20 . . . holder (accommodating member)
21 . . . accommodating portion
22 . . . stopper portion
23 . . . guide portion
23A . . . entrance
23B . . . first guide portion
23C . . . second guide portion
23D . . . third guide portion
24 . . . lock arm
24A . . . outer locking portion
40 . . . sub-housing
40A . . . cavity
40B . . . locking lance
41 . . . sub-housing
42 . . . sub-housing
43 . . . sub-housing
44 . . . sub-housing
45 . . . sub-housing (housing)
45A . . . first surface
45B . . . second surface
45C . . . releasing portion
60 . . . detecting member
61 . . . pressing portion
61A . . . pressing surface
62 . . . arm portion
62A . . . arm body
62B . . . locking portion
62C . . . tip surface
63 . . . locking arm
63A . . . locking arm body
63B . . . locking projection
64 . . . guide projection
65 . . . guide projection
66 . . . retaining portion
67 . . . deflection restricting portion
80 . . . terminal fitting
90 . . . wire
110 . . . mating connector
120 . . . mating holder
121 . . . mating accommodating portion
122 . . . receptacle
123 . . . inner locking portion
140 . . . mating sub-housing
140A . . . cavity
140B . . . locking lance
141 . . . mating sub-housing
142 . . . mating sub-housing
143 . . . mating sub-housing
144 . . . mating sub-housing
145 . . . mating sub-housing
146 . . . mating sub-housing
180 . . . mating terminal fitting
190 . . . wire
C . . . connector coupling structure
SP . . . support point
VL virtual line

1. A connector, comprising:
a housing;
an accommodating member, the housing being fit into the accommodating member from behind; and
a detecting member to be mounted into the accommodating member movably between a standby position and a detection position forward of the standby position,
the accommodating member including a stopper portion,
the detecting member including an arm portion cantilevered forward,
the detecting member being restricted from moving forward while being arranged at the standby position by a tip part of the arm portion butting against the stopper portion from behind,
the tip part of the arm portion being pushed by the housing to move in a releasing direction, whereby the detecting member is allowed to move from the standby position to the detection position, in the process of properly fitting the housing into the accommodating member,
the detecting member further including a pressing portion, and
the detecting member being so arranged that the tip part of the arm portion is inclined in a direction opposite to the releasing direction when the pressing portion is pressed with the detecting member arranged at the standby position.

2. The connector of claim 1, wherein:
the pressing portion has a pressing surface, and
the pressing surface is so inclined that an end part on the releasing direction side is inclined in a connection direction of the housing with the detecting member arranged at the standby position.

3. The connector of claim 2, wherein a center of the pressing surface is arranged more on the releasing direction side than a virtual line parallel to the connection direction of the housing and passing through a support point where the detecting member is supported in the accommodating member.

4. The connector of claim 2, wherein:
the accommodating member includes a guide portion for guiding the detecting member from the standby position to the detection position, and
the guide portion guides the detecting member such that an angle of inclination of the pressing surface to a plane orthogonal to the connection direction of the housing is smaller when the detecting member is arranged at the detection position than when the detecting member is arranged at the standby position.

5. The connector of claim 1, wherein:
the arm portion has a tip surface to be butted against the stopper portion from behind, and
the tip surface is so inclined that an end part on the releasing direction side is inclined in a direction opposite to the connection direction of the housing with the detecting member arranged at the standby position.

6. The connector of claim 1, wherein:
the detecting member includes a retaining portion,
the retaining portion is arranged at a position allowing the housing to be fit into the accommodating member with the detecting member arranged at the standby position, and
the retaining portion is arranged at a position preventing the housing from coming out rearward with the detecting member arranged at the detection position.

7. The connector of claim 6, wherein the retaining portion constitutes a part of the pressing portion.
